(19) United States
(12) Patent Application Publication
(10) Pub. No.: US 2026/0168540 A1
(43) Pub. Date: Jun. 18, 2026

(54) Torque Transfer Spline

(71) Applicant: WestCoast Products & Design LLC, Madera, CA (US)

(72) Inventors: Ranjit Singh CHAHAL, Madera, CA (US); Elias Armando AVILA, Madera, CA (US); Leo Allen BEGLEY, Fresno, CA (US); Gurtinder Singh CHAHAL, Madera, CA (US)

(21) Appl. No.: 19/418,484

(22) Filed: Dec. 12, 2025

Related U.S. Application Data
(60) Provisional application No. 63/733,897, filed on Dec. 13, 2024.

(51) Int. Cl. F16D 11/16; F16D 15/00

(52) U.S. Cl. CPC F16D 11/16; F16D 15/00

(57) ABSTRACT

A device and method for detecting control-point activation conditions from a conductive path and/or an expanded conductive area coming in contact with or being within a threshold distance from at least one of a portion of a glove body or a control surface separate from the glove body. The device may include a conductive path configured to be attached to the glove body and an expanded conductive area conductively coupled to the conductive path and configured to be attached to the glove body. The expanded conductive area may be wider than individual portions of the conductive path.

### CROSS REFERENCE TO RELATED APPLICATIONS

This application claims the benefit of priority to U.S. Provisional Ser. No. 63/733,897, filed on Dec. 13, 2024, the entire contents of which is incorporated herein by reference.

### BACKGROUND

In the field of torque transfer mechanisms, existing solutions have typically employed static designs tailored either for live axle or dead axle configurations. Conventional systems generally lack the ability to dynamically transition between these configurations, limiting their versatility and applicability in diverse operational environments. Prior designs have primarily relied on fixed coupling methods that do not allow an axle to switch between live or dead torque transfer configurations. This may result in uneven load distributions and increased stress on critical components.

Torque transfer is typically concentrated at the inner spline element, leading to excessive wear on both the spline and the drive member over time. This localized stress can result in mechanical degradation, reduced operational life, and eventual failure of the system. Furthermore, traditional designs lack multiple attachment points radially outside the inner spline, which could otherwise distribute the load more evenly. The absence of such features exacerbates the wear on central components and increases the likelihood of mechanical failure under high torque loads.

Furthermore, traditional spline designs generally focus on static geometric compatibility, such as fixed circular or hexagonal configurations, without addressing the need for self-alignment or optimized load distribution during torque transfer. This results in manufacturing complexities and operational inefficiencies, particularly in applications requiring precise alignment or scalability across varying component sizes. While some designs incorporate spherical elements for alignment purposes, they often fail to account for the interaction of these elements with the overall torque transfer mechanism, leading to challenges in achieving consistent performance across different applications.

### DESCRIPTION OF THE FIGURES

The accompanying drawings, which are incorporated herein and constitute part of this specification, illustrate exemplary embodiments of the invention, and together with the general description given above and the detailed description given below, serve to explain the features of the invention.

FIGS. 1A and 1B are perspective and axial views, respectively, of the torque transfer spline in accordance with various embodiments.

FIG. 1C is a cross-sectional perspective view of the torque transfer spline of FIGS. 1A and 1B in accordance with various embodiments.

FIG. 1D is a cross-sectional view of the torque transfer spline of FIGS. 1A and 1B at section D-D in FIG. 1B in accordance with various embodiments.

FIGS. 1E and 1F are axial views from section E-E and section F-F in FIG. 1D, respectively, in accordance with various embodiments.

FIG. 2 is an isolation view of a central aperture of an aperture article, in accordance with various embodiments.

FIGS. 3A-3C are perspective and front views of a torque transfer spline in accordance with various embodiments.

FIGS. 4-8 are front views of various different aperture articles with variations to either the pattern of peripheral apertures or the outermost peripheral edges thereof, in accordance with various embodiments.

FIGS. 9A-9B are front views of an aperture article fastened to an external article using a bolt through configuration, in accordance with various embodiments.

FIGS. 10A-10B are front views of an aperture article fastened to an external article using a clamp around configuration, in accordance with various embodiments.

FIG. 11 is a top view of a pair of aperture articles fastened to an external article in a sandwiching configuration, in accordance with various embodiments.

FIG. 12A is an exploded perspective view of an assembly that includes a bearing insert, for a fixed live-axle configuration, aligned for insertion in an aperture article, in accordance with various embodiments.

FIG. 12B is a front view of the assembly of FIG. 12A.

FIG. 12C is a relief view at Detail B in FIG. 12B.

FIG. 13 is a front view of an assembly that includes a bearing insert, for a fixed dead-axle configuration, in accordance with various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

Various embodiments include an advanced torque transfer design that includes an aperture article for use in live and dead axle configurations. The system incorporates a unique spline design with integrated apertures, enabling dynamic transitions between live and dead axle modes. This flexibility allows for both static and on-the-fly adjustments, ensuring compatibility with various application environments. The innovative design features a central aperture with an innermost space and custom-designed outer extension spaces formed as arched contours that accommodate standard spherical components in a unique way that provides self-alignment and load distribution during operation.

The spline profile of the described system may consist of a circular inner surface and outwardly extending circular lobes, forming a unique geometric configuration. These circular lobes are equally spaced radially and positioned on a 1.03125-inch circular pitch, creating a proportional arrangement that optimizes the spline's functional properties. The insertion article is specifically designed to interface with this spline profile, fitting the protrusions created by the circular lobes while intentionally not matching the circular inner surface. This selective fitting ensures that the insertion article relies on the lobes for engagement, simplifying manufacturing and improving the ease of achieving an accurate fit.

The hole pattern associated with the spline profile includes several distinct sets of holes, all centered around the spline. Holes that overlap are converted into slots, ensuring smooth alignment and compatibility. One set consists of twelve #9 holes equally spaced on a 2-inch circular pitch, enabling secure attachment of circular components like wheels, gears, and pulleys, and allowing for increased torque transfer using 10-32 hardware. Another set includes six #18 holes equally spaced on a 1.875-inch circular pitch, providing a lightweight yet robust option for attaching smaller circular components using 8-32 hardware. Additionally, there are four #9 holes arranged in a 1-inch by 2-inch rectangular pattern, designed to bolt components such as rectangular tubes or plates, facilitating torque transfer between circular and square components. A final set includes four #9 holes positioned on a 2.375-inch by 1.375-inch rectangular grid, which can secure 0.375-inch OD×0.196-inch ID round parts and transfer torque effectively through rectangular tubing configurations.

The spline profile serves a dual purpose, functioning as both a torque-bearing structure and a support for bearing alignment. The spline lobes enable simultaneous performance of both functions, enhancing operational efficiency. Furthermore, the spline profile is flexible in its compatibility with various axle configurations, including live axles, dead axles, and shifting applications. This flexibility ensures adaptability across a range of mechanical systems.

The insertion article is designed to match the profile of the circular lobes, ensuring proper alignment and engagement while avoiding dependence on the circular inner surface. This design reduces the complexity of manufacturing, as fewer surfaces must conform to the spline profile. Additionally, the lobes facilitate ball shifting, enhancing the functionality of the assembly.

The hole pattern offers diverse attachment and torque transfer capabilities. The 12 #9 holes on a 2-inch pitch circle provide a robust method for securing circular components and transferring high torque levels. The six #18 holes on a 1.875-inch pitch circle offer a lighter alternative, ideal for smaller components. The 1-inch by 2-inch rectangular grid of #9 holes facilitates connections between circular and square components, while the 2.375-inch by 1.375-inch rectangular grid provides an efficient way to capture and secure rectangular tubing. The holes further support clamping, bolting through, or simultaneous use of both, allowing for increased torque transfer across diverse applications. This versatility makes the system suitable for various mechanical and structural uses.

Various embodiments additionally include one or more sets of peripheral apertures that are engineered for diverse attachment methods, including bolting and clamping, which can be employed independently or concurrently to enhance torque distribution and structural integrity.

Additionally, various embodiments addresses challenges associated with torque transfer mechanisms, such as uneven load distribution and bolt shearing under high torque conditions. By incorporating a hybrid approach to axle configurations and offering scalable compatibility with different tube sizes and shapes, the invention provides a versatile solution for industrial and mechanical applications. Additionally, the design ensures improved manufacturing tolerances and operational reliability, setting a new standard for torque transfer efficiency and durability.

Benefits of the overall central aperture, which includes the innermost space and the plurality of outer extension spaces, include its compatibility with standardized spherical bearing elements commonly used for torque transfer applications. The configuration of the aperture article permits dynamic adjustment of the spherical elements, enabling a transition between dead axle and live axle modes without requiring extensive reconfiguration or additional components.

Benefits of the peripheral apertures include their ability to distribute torque transfer across areas radially outside the central aperture, thereby mitigating wear and potential damage to the outer circular edges of the outer extension spaces. The peripheral apertures facilitate versatile attachment options, such as bolting through or clamping around an external article. For example, a single aperture article may be bolted to an external component, achieving fixed torque transfer at multiple radial locations. Alternatively, or in combination, two aperture articles may clamp around an external article, securing it between them to provide enhanced torque transfer at locations radially outside the central aperture with even further distributed loads.

Benefits of the outer extension spaces being formed to match the dimensions and curvature of spherical bearing elements is that the outer extension spaces enable a capacity for self-location and self-alignment of the spherical bearing elements within the outer extension spaces. This ensures consistent engagement and optimal alignment during operation, enhancing the durability and reliability of the aperture article in torque transfer applications.

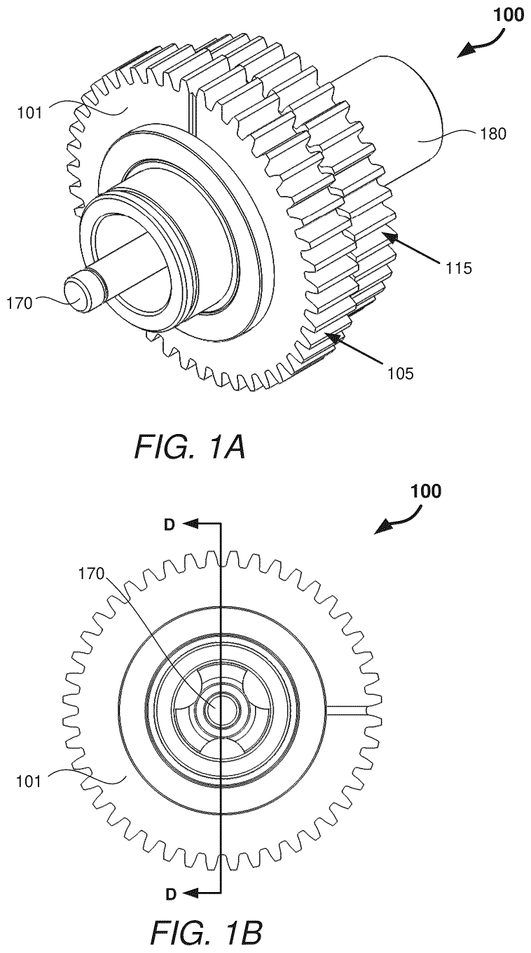

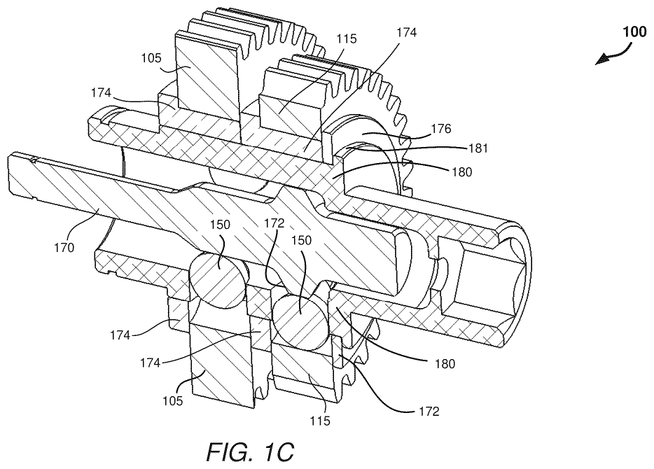

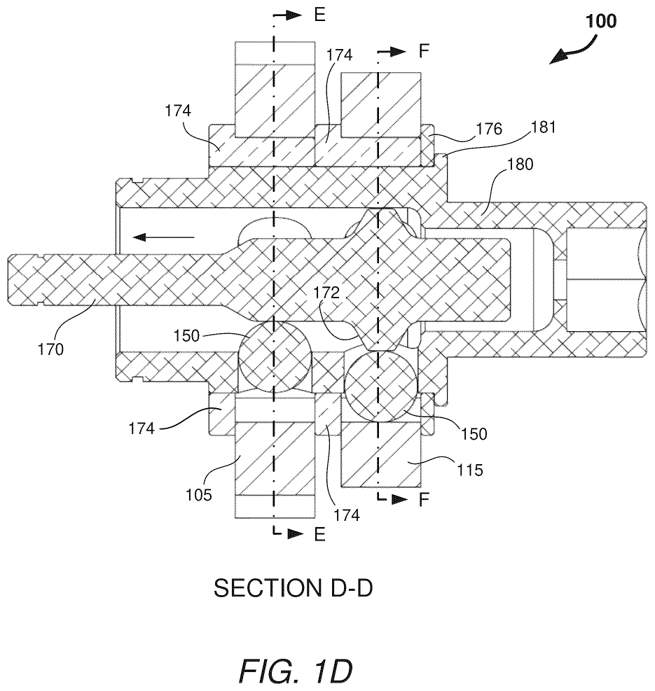

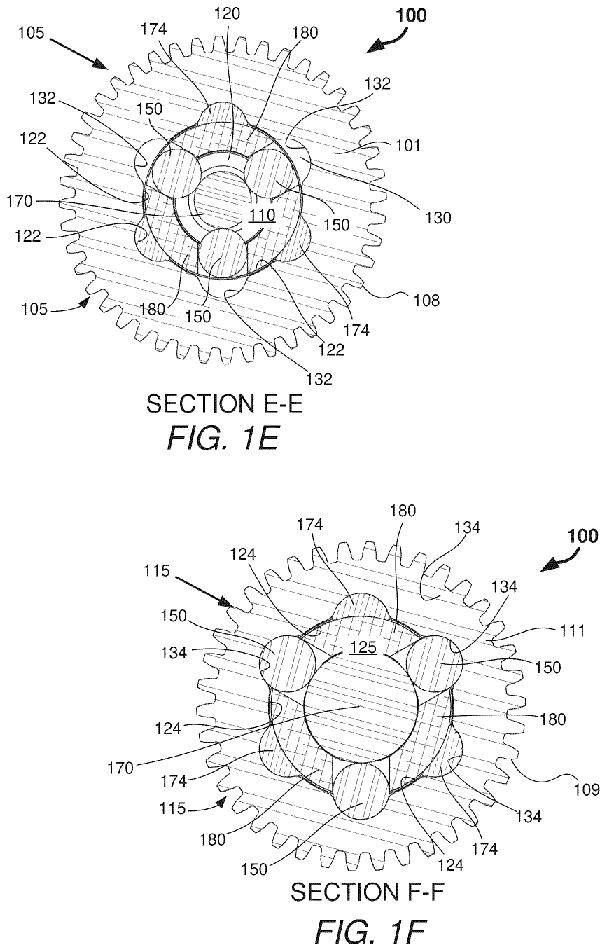

FIGS. 1A-1F illustrate elements of an assembly 100 that includes two aperture articles 105, 115. The two aperture articles 105, 115 are stacked in series, on an insertion article assembly that includes a shifter 170 that is configured shift axially within a hollow shaft 180 and move the circular bearing elements 150 while doing so between a dead axle position (e.g., FIG. 1E) and a live axle position (e.g., FIG. 1F). The shifter 170 may be coupled to an actuator element (not shown) that drives the axial movement of the shifter 170. Meanwhile, the hollow shaft 180 may be affixed to other surrounding structural elements (not shown).

As shown in FIGS. 1C and 1D, the shifter 170 may include a flared section 172 that includes sloped side surfaces that are configured to push the circular bearing elements 150 radially outward as the shifter slides axially toward the circular bearing elements 150. A widest portion of the flared section 172, when axially aligned with the circular bearing elements 150, will hold the circular bearing elements 150 in an outer radial position. That outer radial position corresponds to the live axle position for the aperture article 105, 115 with which the flared section 172 is axially aligned. That live axle position also corresponds to when the circular bearing elements 150 transfer torque to the respective aperture article 105, 115 with which they engage. Once the shifter 170 is moved axially so that the flared section 172 is no longer axially aligned with the circular bearing elements 150, the geometric design of the aperture articles 105, 115 will bias the circular bearing elements 150 to move radially inward to an inner radial position that corresponds to the dead axle position for the aperture article 105, 115 with which the flared section 172 is no longer axially aligned.

In FIG. 1F, the second aperture article 115 is shown engaged by the circular bearing elements 150 and is thus under live axle conditions. In contrast, as shown in FIG. 1E, the first aperture article 105 is not engaged by the circular bearing elements 150 and is thus under dead axle conditions. Should the shifter 170 be pulled far enough axially, (e.g., left in the configuration shown in FIG. 1D) that the flared section is no longer aligned with either the first or second aperture articles 105, 115, then both aperture articles 105, 115 would be in the dead axle condition.

In accordance with various embodiments, and as shown in FIG. 1E, the aperture article 105 includes a body 101 with a central aperture 110 extending completely through the body 101 and a set of outer gear teeth 108 around the outer periphery. The central aperture 110 is configured to receive an insertion article, such as the shifter 170 and hollow shaft 180 in conjunction with bushings 174 or other elongate member(s), and serves as the primary interface for torque transfer and rotational engagement. The central aperture 110 includes specific geometric features that may enhance its functionality. In particular, the central aperture 110 includes an innermost space 120 bounded by an inner circular edge 122 of the body 101. This inner circular edge 122 extends along a circular boundary in arch-like segments interrupted by outer extension spaces 130. In this way, the inner circular edge 122 extends along an inner reference circle, providing a consistent and predictable geometry for interaction with other components, such as cylindrical components like shafts. The innermost space 120 is designed to accommodate a portion of the insertion article 170, ensuring secure placement and alignment within the aperture article 105. This geometry allows for straightforward insertion and removal of the insertion article 170 while maintaining a reliable fit during operation.

Surrounding the innermost space 120 are a plurality of outer extension spaces 130 that extend radially outward beyond the inner reference circle. These outer extension spaces 130 are continuous with the innermost space, creating a cohesive central aperture design. The outer extension spaces 130 may be spaced apart from one another, forming a symmetrical or evenly distributed pattern around the innermost space. This arrangement allows the aperture article 105 to engage with additional structural elements or provide enhanced load distribution. Alternatively, the outer extension spaces 130 may be spaced apart in non-symmetrical and/or unevenly distributed patterns to provide a structure that ensures the insertion article 170 is inserted in a particular orientation.

Each outer extension space 130 is bounded by an inwardly-facing outer curved edge 132 of the body 101 that provides a surface for interfacing with the circular bearing elements 150. Each of the inwardly-facing outer curved edges 132 is configured to matingly receive a circular bearing element 150 through engagement therewith. The geometry of the outer extension spaces 130 ensures that they can matingly receive one circular bearing element 150 in each, with the outer circumference of the bearing element 150 matching substantially all of the inwardly-facing outer curved edge 132. This precise fit minimizes play or movement during operation, ensuring consistent performance and reduced wear over time. Fillets may be used for the transition from the inwardly-facing outer curved edges 132 to the inner circular edge 122, which may help guide the bearing elements 150 into and out of the extension spaces 130. In this way, the outer circumference of the bearing element 150 may match all of the inwardly-facing outer curved edge 132, except the fillet region that transitions into the inwardly-facing outer curved edge 132.

The design of the outer extension spaces 130 enables them to serve as receptacles for the circular bearing elements 150. The circular bearing elements 150 or bushings 174 can be positioned within the outer extension spaces 130 to enhance torque transfer, self-alignment, or rotational stability. The curvature of the outer circumference of each bearing element 150 matches closely with the corresponding inwardly-facing outer curved edge 132, ensuring a tight and secure fit. This configuration allows the aperture article to accommodate standard-sized spherical components, making it compatible with existing systems and enabling efficient integration into various applications.

In accordance with various embodiments, although six outer extension spaces 130 may be included in the body 111, only three bearing elements 150 may be provided. Each of those three bearing elements 150 may be configured to move radially (e.g., pushed by the shifter 170) into one of the six outer extension spaces 130. In order to provide more even torque transfer, every other outer extension space 130 may get occupied with a bearing element 150. Meanwhile, those outer extension spaces 130 not aligned with bearing elements 150 may get filled by a bushing 174.

The bushings 174 may have a ring shape with axially extending nubs configured to sit inside three of the outer extension spaces 130. The axially extending nubs may have an arched outer surface configured to match the curvature of the inwardly-facing outer curved edges 132. The ring-shaped portion of the bushings 174 may extend radially beyond the innermost space 120 of the central aperture 110 to prevent axial movement in at least one axial direction of the aperture article (e.g., 105, 115) mounted thereon. An opposed side of at least one of the aperture articles may include a washer 176 configured to prevent axial movement in the opposite axial direction. The washer 176 may be held in place by an extension shoulder 181 of the hollow shaft 180.

The interplay between the innermost space 120 and the outer extension spaces 130 creates a versatile aperture design. The continuous nature of the geometry ensures structural integrity while allowing for multiple points of engagement with insertion articles or bearing elements. This dual-zone approach enables the aperture article to distribute load effectively, transferring torque not only through the innermost space 120 but also through the outer extension spaces 130, thereby enhancing overall functionality and durability.

As shown in FIG. 1F, the second aperture article 115 includes virtually all the same features as the first aperture article 105 but with different dimensions. Thus, the second aperture article 115 includes a body 111 with a central aperture 125 extending completely through the body 111 and a set of outer gear teeth 109 around the outer periphery. The central aperture 125 includes an innermost space that is circular and bounded by an inner reference circle that is coincident with an inner circular edge 124 of the body 111. The central aperture 125 also include a plurality of outer extension spaces that extend radially outward beyond the innermost space and the inner reference circle. This inner circular edge 124 extends along a circular boundary in arch-like segments interrupted by the outer extension spaces, which form smaller arches connecting adjacent side portions of separate the inner circular edges 124. Each outer extension space is bounded by an inwardly-facing outer curved edge 134 of the body 111 that provides a surface for interfacing with the circular bearing elements 150 or bushings 174.

These design features make the aperture article 105 suitable for a wide range of applications, including mechanical coupling, torque transfer, and alignment in dynamic systems. The precise configuration of the innermost space and outer extension spaces ensures that the aperture article can perform reliably under varying operational conditions, accommodating both standard and customized components as required.

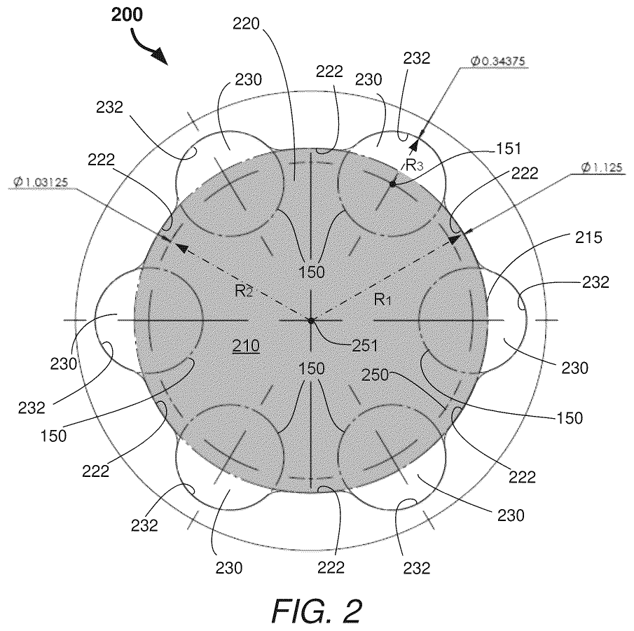

FIG. 2 is an isolation view of the central aperture 210 of an aperture article 200, in accordance with various embodiments. Various characteristics described herein with regard to the aperture article 200 apply to all the embodiments described herein. For example, the innermost space and the outer extension spaces are elements common to various embodiments described herein (e.g., aperture articles 105, 115, 200, 300, 400, 500, 600, 700, 800, 900, 1000, 1300).

The central aperture 210 includes an innermost space 220 (illustrated as a gray shaded area in FIG. 2) and outer extension spaces 230 that are contiguous with the innermost space 220. The innermost space 220 is bounded by an inner circular edge 222 defined by a first radius R₁ from a center point 251. This inner circular edge 222 extends along a circular boundary in arch-like segments interrupted by the outer extension spaces 230. In this way, the inner circular edge 222 extends along an inner reference circle 215. Surrounding the innermost space are the outer extension spaces 230 that extend radially outward beyond the inner reference circle 215. Each outer extension space 230 is bounded by an inwardly-facing outer curved edge 232 that provides a surface for interfacing with a circular bearing element (e.g., 150).

The extension spaces 230 provide self-location and self-alignment features for the assembly due to their geometry and the interaction with the circular bearing elements 150. Each extension space 230 is defined by an inwardly-facing outer curved edge 232 that closely matches the outer circumference of the circular bearing element 150. This precise match minimizes play and ensures that the bearing element 150 remains securely seated within the extension space 230 during operation. Additionally, the evenly spaced arrangement of the extension spaces 230 around the inner circular edge 222 creates a symmetric design, which contributes to consistent alignment and reliable performance when torque is applied.

The positioning of a center point 151 of the curvature of the inwardly-facing outer curved edge 232 biases the circular bearing element 150 to roll out of the extension space 230 when the circular bearing element 150 is not radially supported, such as by the flared section (e.g., 172) of a shifter (e.g., 170). Each center point 151 of each inwardly-facing outer curved edge 232 sits along an inner diameter 250 defined by a second radius R₂ from the center point 251. The second radius R₂ is thus smaller than the first radius R₁. When the center point 151 of the bearing element's curvature is positioned radially inward from the inner circular edge 222, which corresponds to the inner reference circle 215, the bearing element 150 experiences a torque or force vector that naturally encourages it to roll out of the extension space 230 (i.e., radially inwardly). This bias is beneficial for applications where dynamic switching between states, such as engaging and disengaging torque transfer, is desired. The geometry ensures that, when the system is not actively applying a radially outward retaining force, the bearing element 150 can move out of the extension space 230, allowing the assembly to transition into a free-spinning or disengaged state (i.e., dead axle condition). This design feature enhances the functionality and adaptability of the aperture article in various operational scenarios.

In this way, in various embodiments the aperture article is configured to facilitate dynamic transitions between live axle and dead axle configurations. The central aperture includes an inner circular edge and radially extending outer extension spaces, allowing for the insertion of standardized spherical elements. When the spherical elements are shifted into the outer extension spaces, the system locks, enabling torque transfer along the shaft. Conversely, shifting the spherical elements outwards permits free spinning, allowing the system to operate in a disengaged mode. This versatility supports applications requiring the rapid alternation between live and dead axle states without the need for significant manual adjustments.

The central aperture's geometry may be designed to interact specifically with spherical bearing elements. These elements self-locate within the outer extension spaces, providing a secure fit that optimizes torque transfer and minimizes the risk of misalignment. The spherical elements also act as self-alignment devices, ensuring that the system operates smoothly even under dynamic conditions. This design reduces manufacturing tolerances and assembly complexity while enhancing the overall durability of the aperture article.

In various embodiments, the aperture article may be configured to enable dynamic switching between live axle and dead axle configurations on a single shaft. This feature eliminates the need for separate systems dedicated to live or dead axle functionality, offering a versatile solution that adapts to changing operational requirements. The central aperture and associated spherical bearing elements facilitate this functionality by engaging or disengaging with the shaft, depending on the selected configuration.

The dynamic switching capability may be achieved through a mechanism that shifts spherical elements between engaged and disengaged positions. When the spherical elements are engaged, the system operates in live axle mode, transferring torque directly through the central shaft. When disengaged, the system switches to dead axle mode, allowing the shaft to rotate freely without torque transfer. This dynamic adjustability is particularly advantageous in applications where frequent change between these states is necessary, such as in modular industrial systems or transport machinery.

Various embodiments leverage the dynamic switching capability to provide enhanced operational efficiency in hybrid systems. By allowing users to dynamically select between live and dead axle configurations, the system reduces downtime and manual intervention. This embodiment is especially useful in scenarios requiring rapid adaptation to varying load conditions, such as in material handling equipment or automated assembly lines.

Various embodiments integrate control mechanisms that automate the dynamic switching process. Sensors or actuators can detect load conditions and automatically transition the system between live and dead axle modes. This automation ensures improved performance without operator intervention, enhancing both efficiency and safety in high-demand environments.

Various embodiments may also incorporate the ability to pair multiple aperture articles on the same shaft, with one configured as a live axle and the other as a dead axle. This dual setup allows for synchronized operation, where one article can transfer torque while the other provides rotational freedom. This arrangement may be beneficial in complex mechanical systems requiring simultaneous control over torque application and rotational movement, such as robotics or precision machinery.

The aperture article, in accordance with various embodiments, may enable dynamic switching with various shaft sizes and geometries. The central aperture and its associated features, such as spherical bearing elements and extension spaces, are designed to accommodate a range of standard and non-standard shaft profiles. This adaptability ensures that the system can be easily integrated into existing mechanical setups, providing a cost-effective upgrade path for users looking to enhance their torque transfer capabilities with dynamic functionality.

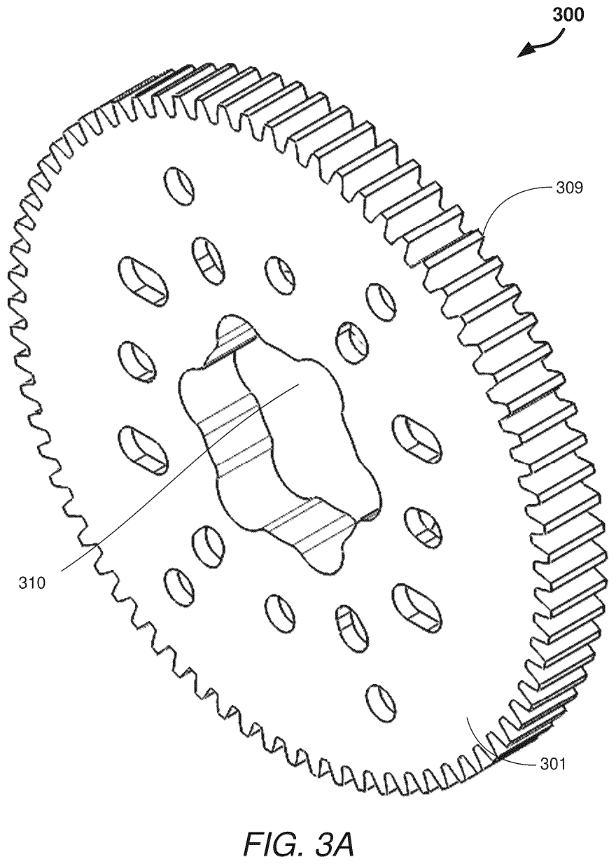

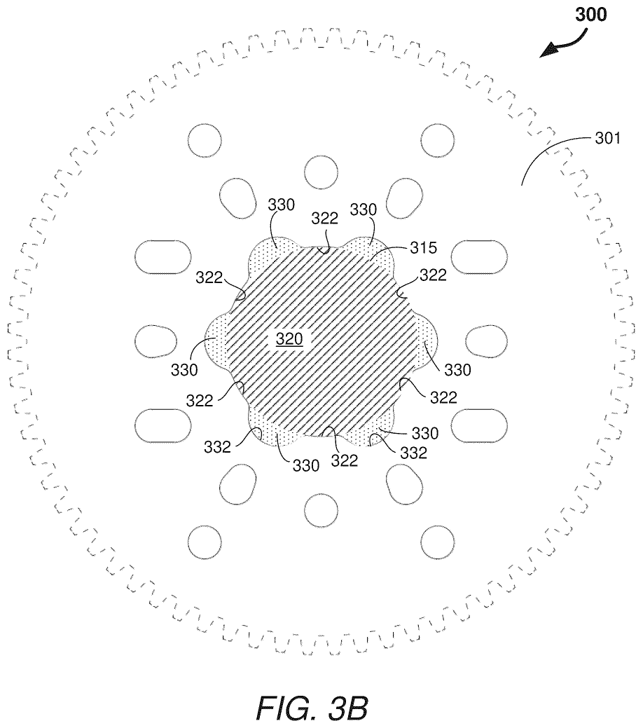

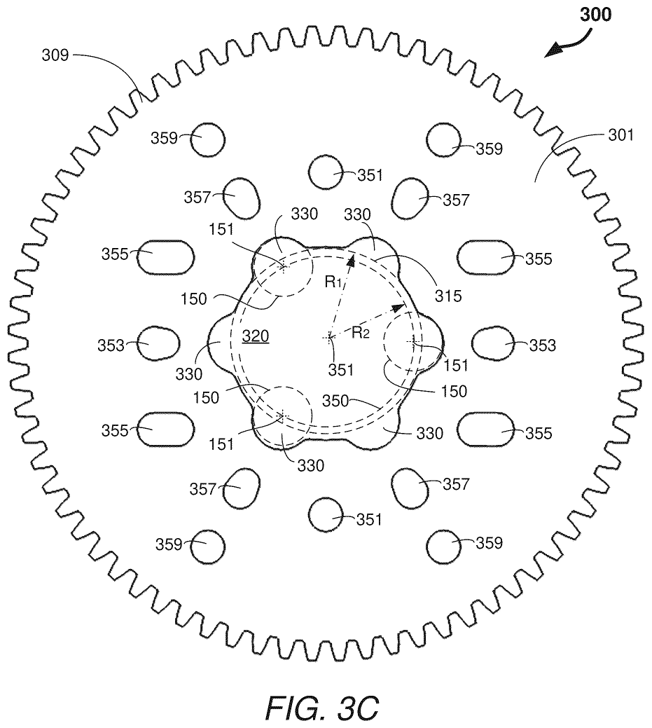

FIGS. 3A-3C illustrate an aperture article 300 in accordance with various embodiments. The aperture article 300 includes a body 301 with a central aperture 310 and various peripheral features, such as gear teeth 309 and peripheral apertures. The central aperture 310 may serve as a primary opening in the center of the body 301. FIG. 3B illustrates, with shading, the different regions of the central aperture 310. The central aperture 310 is defined by two different types of spaces that together form the central aperture 310, namely the innermost space 320 and a plurality of outer extension spaces 330. The innermost space 320 is bounded by an inner circular edge 322 of the body 301. The inner circular edge 322 extends along an inner reference circle 315, except where interrupted by the outer extension spaces 330. The inner reference circle 315 is defined by a first radius R₁ from an aperture center-point of the aperture 310.

The outer extension spaces 330 are distributed around the innermost space 320 and extend radially beyond the inner circular edge 322. The opening of the innermost space 320 is continuous with the openings of the outer extension spaces 330. Each outer extension space 330 is defined by its inwardly-facing outer circular edge 332 and is configured to receive the circular bearing elements (e.g., 150) therein.

In accordance with various embodiments, a bearing center-point, which is the location of a center of the circular bearing elements (e.g., 150) when fully seated in the outer extension space 330, should be disposed radially inside the inner reference circle 315. In this way, a further reference circle 350 that is centered on the aperture 310 center-point and extends through all or several of the bearing center-points is defined by a second radius (e.g., R₂) from the aperture center-point of the aperture 310. Each center point 151 of each inwardly-facing outer circular edge 332 sits along the reference circle 350 defined by the second radius R₂ from the center point 151. The second radius R₂ is thus smaller than the first radius R₁.

In accordance with various embodiments, and as particularly shown in FIG. 3C, the aperture article 300 may additionally include peripheral apertures 351, 353, 355, 357, 359. The peripheral apertures 351, 353, 355, 357, 359 are sets of apertures arranged radially outside the central aperture in distinct patterns. Different shapes and sizes are apparent, likely providing options for bolting, clamping, or other attachment mechanisms.

Outer gear teeth 309, which surround the entire perimeter of the aperture article 300 may be evenly spaced along the circumference. Such outer gear teeth 309 may provide a functionality for engaging with other rotational components, such as gears or drive mechanisms.

The figure illustrates how the central aperture, outer extension spaces, and peripheral apertures combine to provide various mechanical functionalities, such as torque transfer, component alignment, and secure attachment options. Let me know if you'd like a more detailed description of specific features.

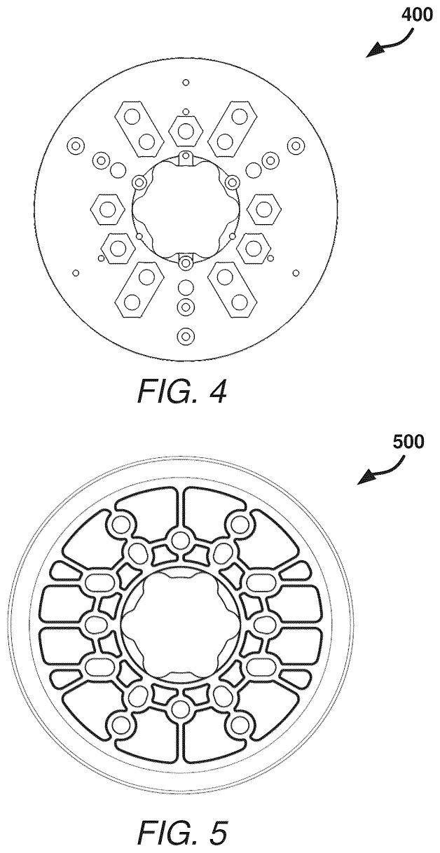

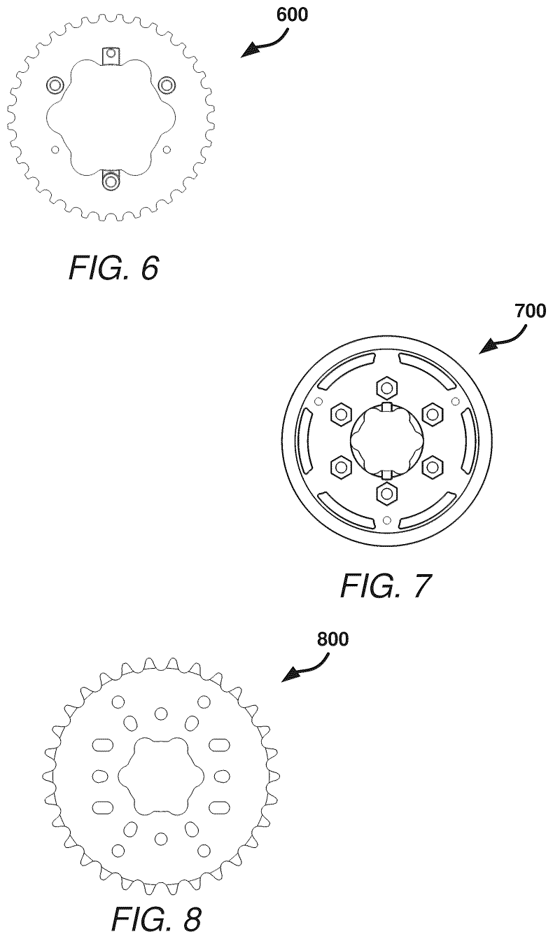

FIGS. 4-8 illustrate aperture articles 400, 500, 600, 700, 800 with variations to either the pattern of peripheral apertures or the outermost peripheral edges thereof, in accordance with various embodiments.

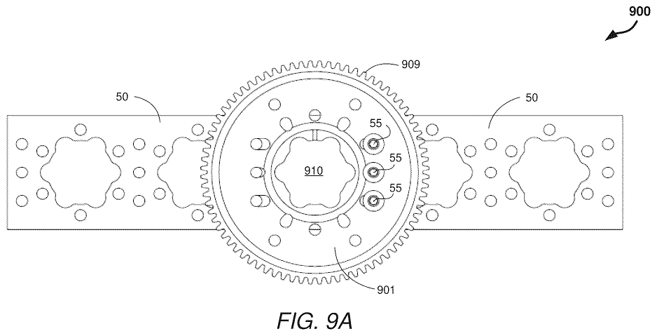

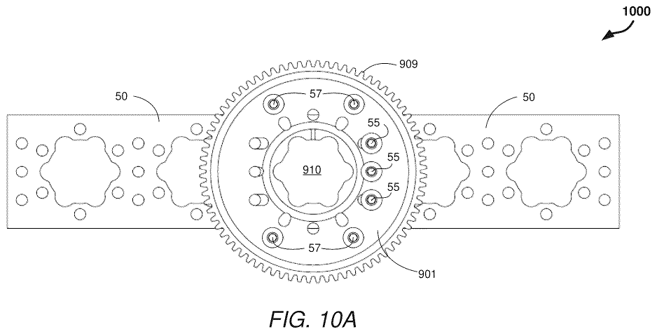

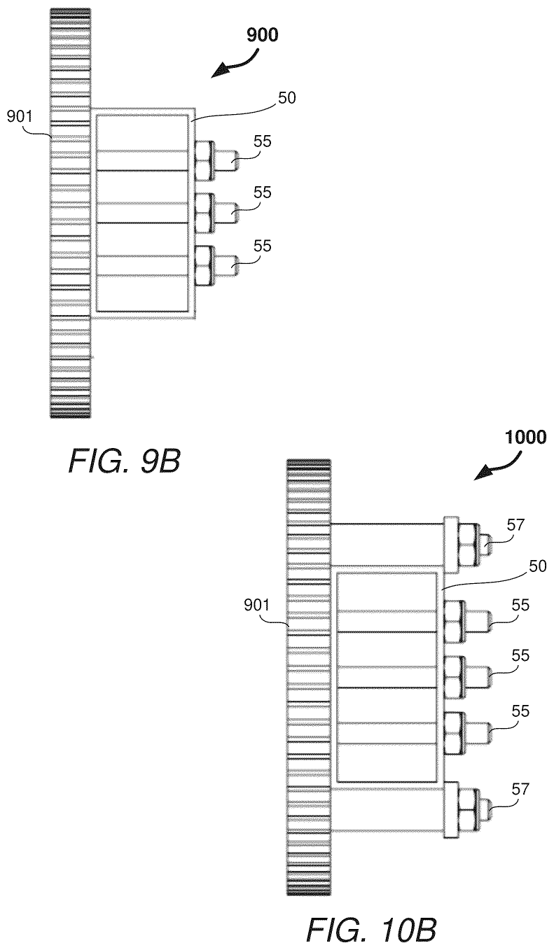

FIGS. 9A-10B illustrate an aperture article 900 with a body 901 fastened to an external article 50. The aperture article may include outer gear teeth 909 In accordance with various embodiments, the external article 50 may be fastened to the aperture article 900 via one or more of the peripheral apertures. The peripheral apertures positioned radially outside the central aperture 910 may provide multiple attachment options for fixing the external article 50 to the aperture article 900. For example, the peripheral apertures enable bolting through or clamping around the external article 50, such as tubing or brackets, to establish secure connections.

The peripheral apertures may be arranged in patterns that accommodate different sizes and shapes of external components, including rectangular, square, or circular cross-sections. This design ensures consistent torque transfer, even when operating under high loads, by allowing simultaneous bolting and clamping. This design allows users to transfer torque not only through the spline but also through attachments made possible by the peripheral apertures. This hybrid configuration supports applications requiring maximum torque capacity, as it distributes force across both the inner and outer regions of the article. By doing so, the system minimizes wear on individual components and extends the operational life of the aperture article.

The various embodiments, enable scalability and adaptability. The peripheral apertures may be arranged in sets that accommodate varying diameters of external components. For example, one set of apertures may be aligned for smaller tubes, while another set supports larger tubes. This scalability allows users to select appropriate apertures for their specific application, ensuring a snug fit and reliable operation. The modular design may also permit retrofitting of the aperture article into existing systems with minimal modifications.

FIGS. 9A and 9B illustrate an example of the external article 50 being secured to the aperture article 900 using a bolt through configuration. In particular, bolts 55 may be inserted through peripheral apertures and also pass through the external article 50. An end of each bolt may include a nut and optionally one or more fasteners and/or locking adhesive to keep the assembly securely fastened.

FIGS. 10A and 10B illustrate an example of an assembly 1000 with the external article 50 being secured to the aperture article 900 using a clamping around configuration, as well as the bolt through configuration. The addition of clamp around bolts 57 may add further stability and torque capacity. In particular, clamp around bolts 57 may be inserted through peripheral apertures, but rather than passing through the external article 50 they extend along an outer edge of the external article. An end of each clamp around bolt 57 may include a nut and optionally one or more fasteners and/or locking adhesive to keep the assembly securely fastened. In addition, the clamp around bolt 57 shaft may include a bushing (e.g., an elastic bushing) along the shaft of the bolt 57 as a vibrational dampener.

Alternatively, the clamp around bolts 57 could be used to secure the external article 50 to the aperture article 900 without the inclusion of the bolt through bolts 55.

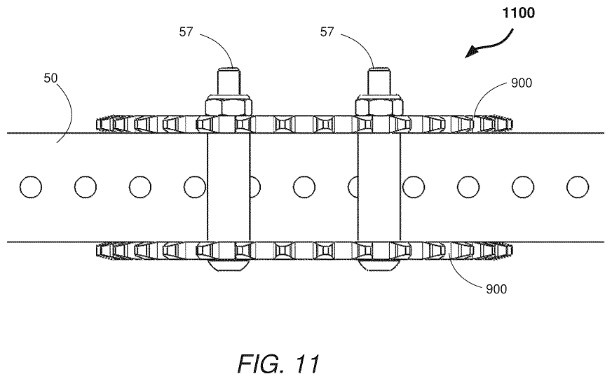

FIG. 11 illustrates an assembly 1100 with a pair of aperture articles 900 fastened to the external article 50 in a sandwiching configuration, in accordance with various embodiments. Multiple aperture articles 900 may sandwich the external article 50, enhancing load distribution and structural stability. For instance, two aperture articles 900 can be used on opposite sides of the external article 50, which may be a tubular element, using the peripheral apertures of each aperture article 900 clamped and bolted around the external component. The sandwiching configuration may be achieved using either or both of the bolt through or clamp around configurations described above with regard to FIGS. 9A-10B.

The sandwiching configuration divides the load across multiple points, reducing stress on individual bolts and preventing localized mechanical wear or failure. The arrangement is particularly effective for transferring torque across larger radii, where distributed load paths are critical for maintaining system integrity.

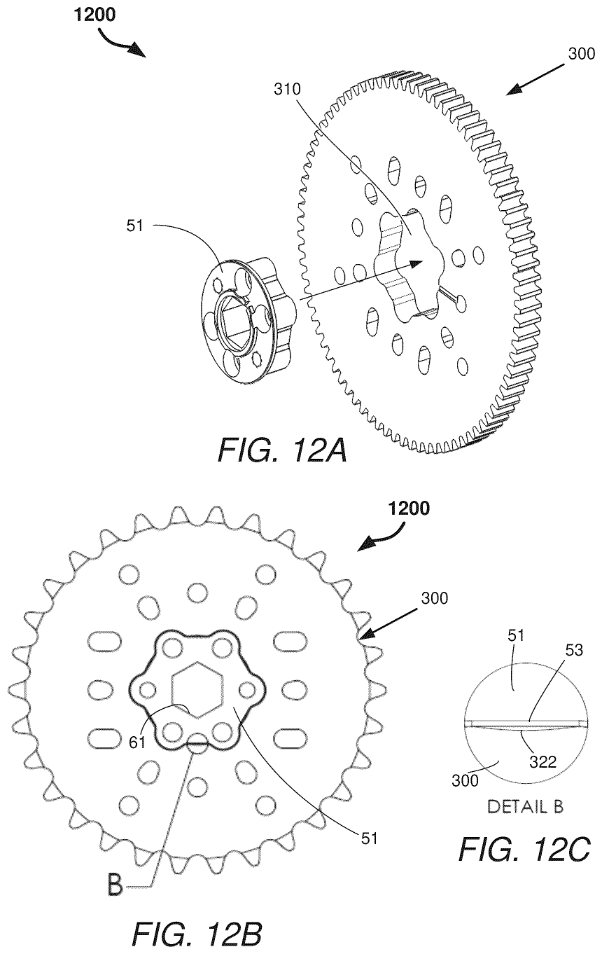

FIGS. 12A-12C illustrate further aspects of another assembly 1200 that demonstrates another way an aperture article 300 may be used, in accordance with various embodiments. As shown in FIGS. 12A and 12B, the assembly 1200 includes a bearing insert 51 inserted into the central aperture 310 of the aperture article 300 to provide a fixed live-axle configuration that transfers torque from the inner walls of an internal hex aperture 61 through the bearing insert 51 to the aperture article 300 via the inwardly-facing outer curved edges (e.g., 332). Alternatively, the bearing insert 51 could include a cylindrical internal aperture for providing a fixed dead-axle configuration (i.e., an insert article in the cylindrical internal aperture could free-spin without transferring any torque to the bearing insert 51 or the aperture article 300).

FIG. 12C illustrates relief detail from the region indicated in FIG. 12B. In particular, FIG. 12C shows how the bearing insert 51 may be configured to leave a gap between the inner circular edge 322 and an opposed surface 53 of the bearing insert 51. Providing such a gap may facilitate machining or otherwise forming the bearing insert 51 without having to include high-precision tolerances in the areas other than the portions configured to engage the inwardly-facing outer circular edges 332.

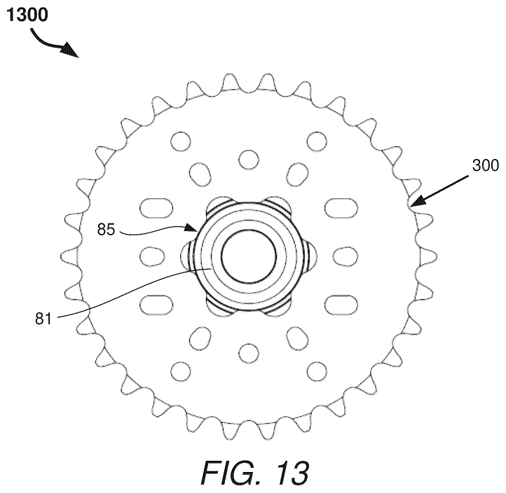

FIG. 13 illustrates another assembly 1300 that demonstrates another way an aperture article 300 may be used, in accordance with various embodiments. As shown in FIG. 13, the assembly 1300 includes a bearing insert 81 with a circular bearing surface 85 inserted into the central aperture 310 of the aperture article 300. The circular bearing surface 85 may spin relative to the inner circular edge (e.g., 322) of the aperture article 300. The bearing insert 81 may provide a fixed dead-axle configuration that does not transfer torque from the bearing insert 81 to the aperture article 300 via either the inner circular edge (e.g., 322) or the inwardly-facing outer curved edges (e.g., 332).

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. An aperture article, comprising:
a body having a central aperture extending through the body and configured to receive an insertion article therein, wherein the central aperture is defined by:
an innermost space having an inner circular edge; and
a plurality of outer extension spaces that are continuous with and extend radially beyond the innermost space, wherein the outer extension spaces are spaced apart from one another around the innermost space, wherein the inner circular edge extends along an inner reference circle except where interrupted by the outer extension spaces, wherein the outer extension spaces are each defined by an inwardly-facing outer circular edge, wherein each of the outer extension spaces are configured to matingly receive a circular bearing element therein, wherein an outer circumference of the circular bearing element is configured to match substantially all of the inwardly-facing outer circular edge of at least one of the outer extension spaces.

2. The aperture article of claim 1, further comprising:
a first set of peripheral apertures disposed radially outside the central aperture.

3. The aperture article of claim 2, wherein at least one peripheral aperture of the first set of peripheral apertures is a slotted aperture.

4. The aperture article of claim 2, further comprising:
a second set of peripheral apertures disposed radially outside the central aperture, wherein the first set of peripheral apertures define a first pattern outside the central aperture and the second set of peripheral apertures define a second pattern outside the central aperture that is different from the first pattern.

5. The aperture article of claim 1, wherein a center point of the circular bearing element is disposed radially inside the inner reference circle when the circular bearing element is fully seated in one of the outer extension spaces.

6. The aperture article of claim 1, wherein the body further comprises gear teeth disposed around an outer perimeter of the body.

7. The aperture article of claim 2, wherein the first set of peripheral apertures is configured to receive fasteners for at least one of bolting through an external article or clamping around the external article.

8. The aperture article of claim 1, wherein the outer extension spaces are equally spaced around the innermost space in a symmetrical pattern.

9. The aperture article of claim 1, wherein the body is configured to be positioned in series with a second aperture article along an insertion article assembly, wherein the insertion article assembly includes a shifter configured to move axially and transition the circular bearing element between a dead axle position and a live axle position.

10. The aperture article of claim 2, wherein the first set of peripheral apertures is arranged in a circular pattern at a first radial distance from a center point of the central aperture, and wherein the aperture article further comprises a third set of peripheral apertures arranged in a rectangular pattern.

11. An aperture article, comprising:
a body having a central aperture extending through the body, wherein the central aperture includes an innermost space bounded by an inner circular edge that extends along an inner reference circle, and a plurality of outer extension spaces extending radially beyond the inner reference circle, wherein each outer extension space is bounded by an inwardly-facing outer curved edge configured to matingly receive a circular bearing element; and
a plurality of peripheral apertures disposed radially outside the central aperture and configured to receive fasteners for securing an external article to the body, wherein the peripheral apertures are arranged in at least two distinct patterns to accommodate different external article configurations.

12. The aperture article of claim 11, wherein at least one peripheral aperture is a slotted aperture.

13. The aperture article of claim 11, wherein a center point of the circular bearing element is disposed radially inside the inner reference circle when the circular bearing element is fully seated in the outer extension space.

14. The aperture article of claim 11, wherein the body further comprises gear teeth disposed around an outer perimeter of the body.

15. The aperture article of claim 11, wherein the peripheral apertures are configured to receive fasteners for at least one of bolting through the external article or clamping around the external article.

16. A torque transfer assembly, comprising:
an insertion article assembly including a shifter configured to move axially;
a first aperture article having a body with a central aperture, wherein the central aperture includes an innermost space and a plurality of outer extension spaces extending radially outward from the innermost space;
a plurality of circular bearing elements positioned within the outer extension spaces of the first aperture article; and
wherein the shifter includes a flared section configured to engage the circular bearing elements and move the circular bearing elements radially between an inner radial position corresponding to a dead axle condition and an outer radial position corresponding to a live axle condition, wherein in the live axle condition the circular bearing elements transfer torque between the insertion article assembly and the first aperture article.

17. The torque transfer assembly of claim 16, further comprising:
a second aperture article positioned in series with the first aperture article along the insertion article assembly, wherein the shifter is configured to selectively engage the circular bearing elements with either the first aperture article or the second aperture article.

18. The torque transfer assembly of claim 16, wherein the flared section includes sloped side surfaces configured to push the circular bearing elements radially outward as the shifter moves axially toward the circular bearing elements.

19. The torque transfer assembly of claim 16, wherein the first aperture article further comprises a plurality of peripheral apertures disposed radially outside the central aperture and configured to receive fasteners for securing an external article to the body.

20. The torque transfer assembly of claim 16, wherein the outer extension spaces are configured such that the circular bearing elements are biased to move radially inward to the inner radial position when the flared section is not axially aligned with the circular bearing elements.
